(19) United States
(12) Patent Application Publication
(10) Pub. No.: US 2015/0191307 A1
(43) Pub. Date: Jul. 9, 2015

(54) Solar powered frac sand making silo

(71) Applicant: Pierre Trudel, Saskatoon (CA)

(72) Inventor: Pierre Trudel, Saskatoon (CA)

(21) Appl. No.: 14/146,817

(22) Filed: Jan. 3, 2014

(51) Int. Cl. B65D 90/66; H02S 40/38; H02S 10/20; B65D 88/54; B65D 90/48

(52) U.S. Cl. CPC B65D 90/66; B65D 88/54; B65D 90/48; H02S 10/20; H02S 40/38

(57) ABSTRACT

A solar powered system for operating the gates, chutes, and lid of a fracking silo. The solar powered system comprises at least one solar panel adapted to be attached to an outer surface of the fracking silo; at least one solar power battery adapted to be housed within a base portion of the fracking silo. Each the at least one solar power battery being electrically connected to the at least one solar panel and adapted to store the solar power absorbed by the at least one solar panel, and a control panel adapted to be placed within the fracking silo and electrically connected to the at least one solar power battery, and adapted to control and transfer the solar power stored by the at least one solar power battery, wherein the control panel includes a solar charger control device adapted to regulate the at least one solar power battery and transfer a desired amount of solar power therefrom to actuators within the fracking silo to thereby open and close the gates and lid, and move the chutes of the fracking silo.

### FIELD OF THE INVENTION

The present invention relates generally to sand fracking but more particularly to a solar powered frac sand making silo.

### BACKGROUND OF THE INVENTION

Frac sand is not used straight from the ground. It requires processing to optimize its performance. After mining it is taken to a processing plant. There it is washed to remove fine particles. After washing the sand is stacked in piles to allow the wash water to drain off. This operation is done outdoors and is restricted to times of the year when temperatures are above freezing. After the sand is drained it is placed in an air dryer to remove all moisture. The dry grains are then screened to obtain specific size fractions for different customers. This operation is done in fracking silos which are sometimes located near to where the sand will be used.

Since oil fields are located in remote regions where grid electricity is not available, it is preferred to have a silo that can generate its own electricity from a generator or renewable clean energy such as wind or sun.

Generating electricity from the sun has its own set of problems because inconsistencies in energy production requires the use of storage batteries and various way of modulating the output for consistency.

This is an issue not quite resolved by the prior art.

### SUMMARY OF THE INVENTION

In view of the foregoing disadvantages inherent in the known devices now present in the prior art, the present invention, which will be described subsequently in greater detail, is to provide objects and advantages which are:

To provide for a reliable sun powered fracking silo.

In order to do so, the invention consists in a solar powered system for operating the gates, chutes, and lid of a fracking silo. The solar powered system comprises at least one solar panel adapted to be attached to an outer surface of the fracking silo; at least one solar power battery adapted to be housed within a base portion of the fracking silo. Each the at least one solar power battery being electrically connected to the at least one solar panel and adapted to store the solar power absorbed by the at least one solar panel, and a control panel adapted to be placed within the fracking silo and electrically connected to the at least one solar power battery, and adapted to control and transfer the solar power stored by the at least one solar power battery, wherein the control panel includes a solar charger control device adapted to regulate the at least one solar power battery and transfer a desired amount of solar power therefrom to actuators within the fracking silo to thereby open and close the gates and lid, and move the chutes of the fracking silo.

The control panel further includes switches, electronic relays, and a 64 minute timer, adapted such that a predetermined sequence of operations can be performed by the solar power system to power the gates, chutes, and lid of the fracking silo at predetermined times and following predetermined events. The switches are manually operable.

The control panel further includes a remote control mechanism, such that the control panel is adapted to be controlled from a remote location.

The remote control mechanism further includes a wireless internet communication mechanism adapted to be accessed and used by a controller remotely via an internet connection,

The wireless internet communication mechanism includes a WIFI controller program, a WIFI board, a WIFI modem, a WIFI antenna, and a WIFI locking mechanism adapted to lock unauthorized users from accessing the wireless internet communication mechanism.

The solar charger control device includes a solar power battery temperature sensor adapted to send temperature information of the at least one solar power battery to the solar charger control device.

The solar charger control device includes a direct-current to alternating-current (DC/AC) converter mechanism electronically connected between the at least one solar power battery and said gates, lid, and chute of said fracking silo.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be made to the accompanying drawings and descriptive matter which contains illustrated preferred embodiments of the invention.

### BRIEF DESCRIPTION OF THE DRAWINGS

FIGS. 1a-b Front and side views of the inside of the invention.

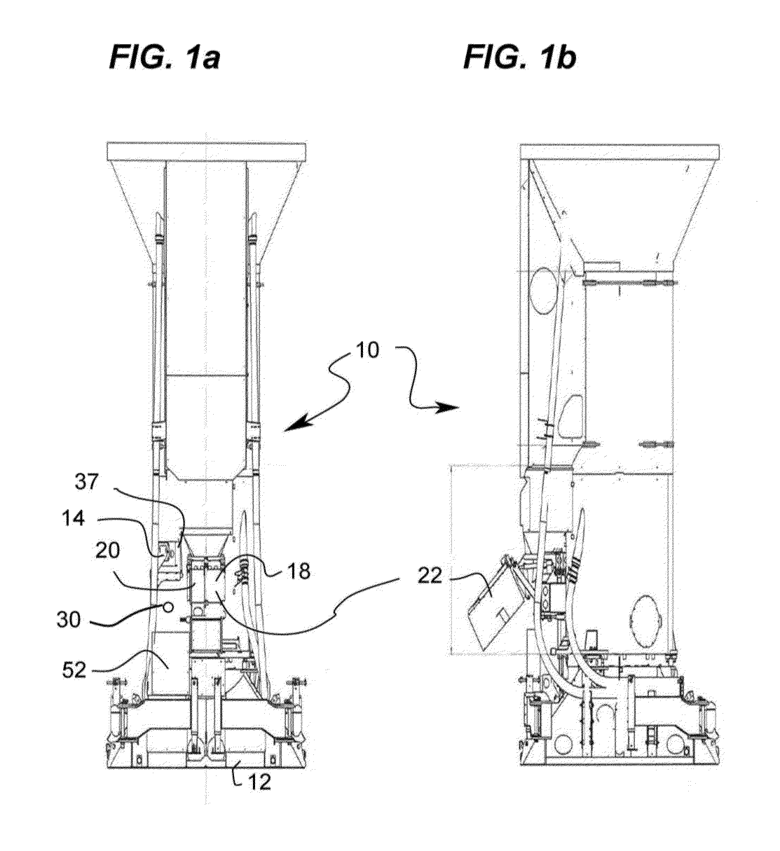

FIG. 2 Top view of the silo.

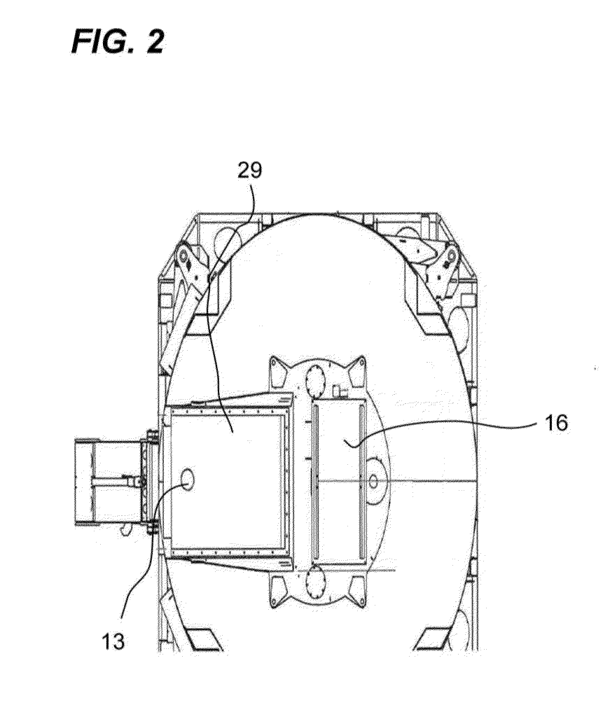

FIGS. 3a-b Front and side views of the exterior of the silo.

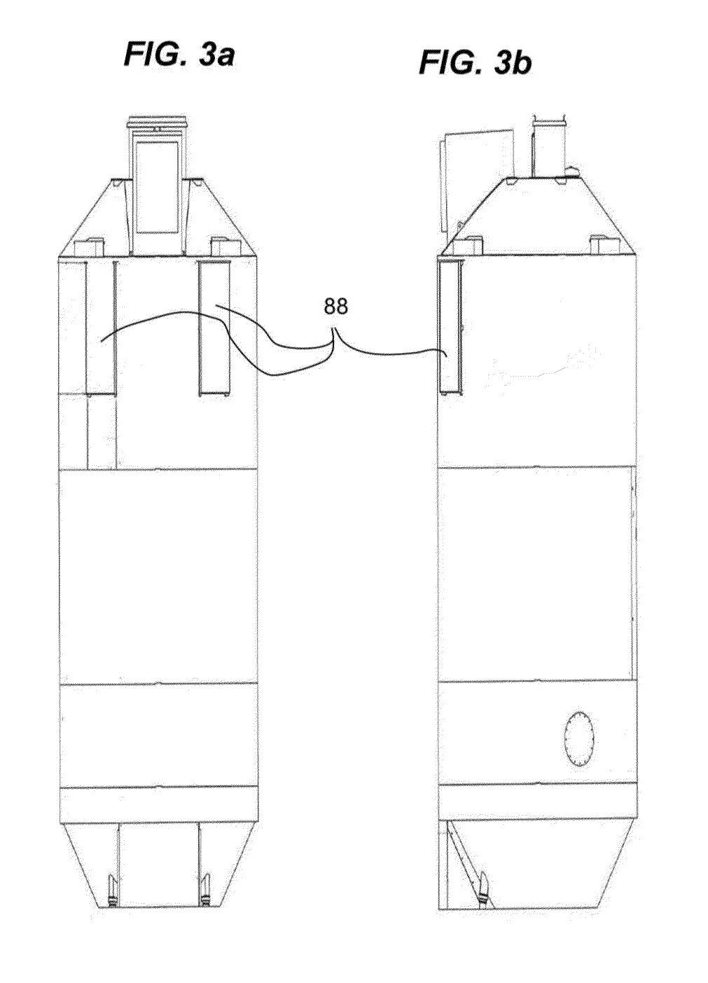

FIG. 4 Front view of the pendant.

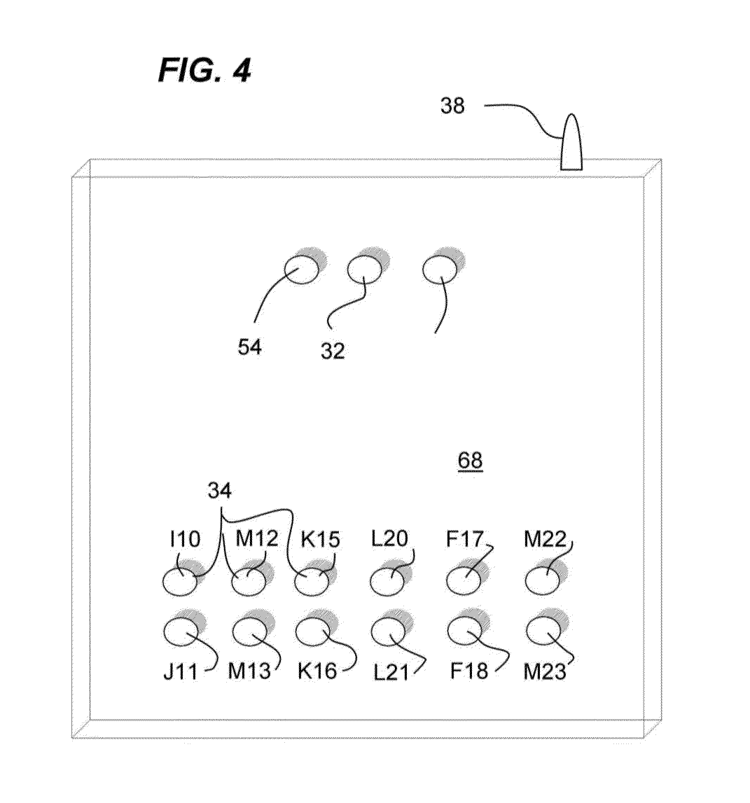

FIG. 5 Schematic view of the DC electrical junction box.

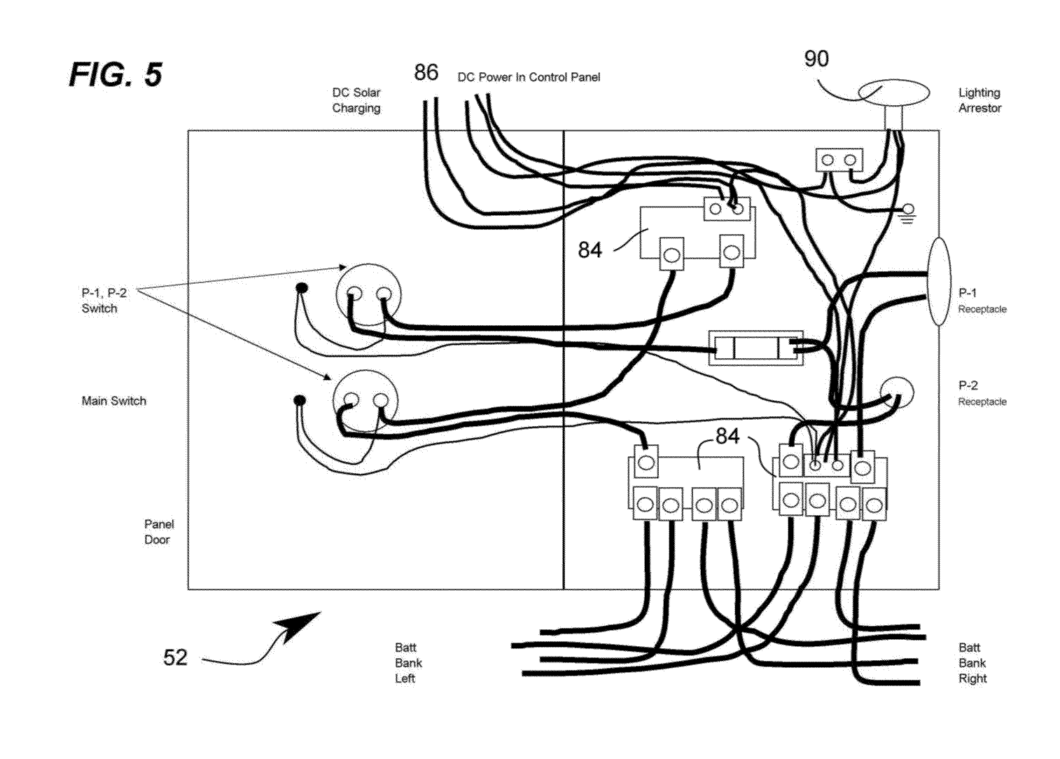

FIG. 6 Schematic view of the manual switching control panel.

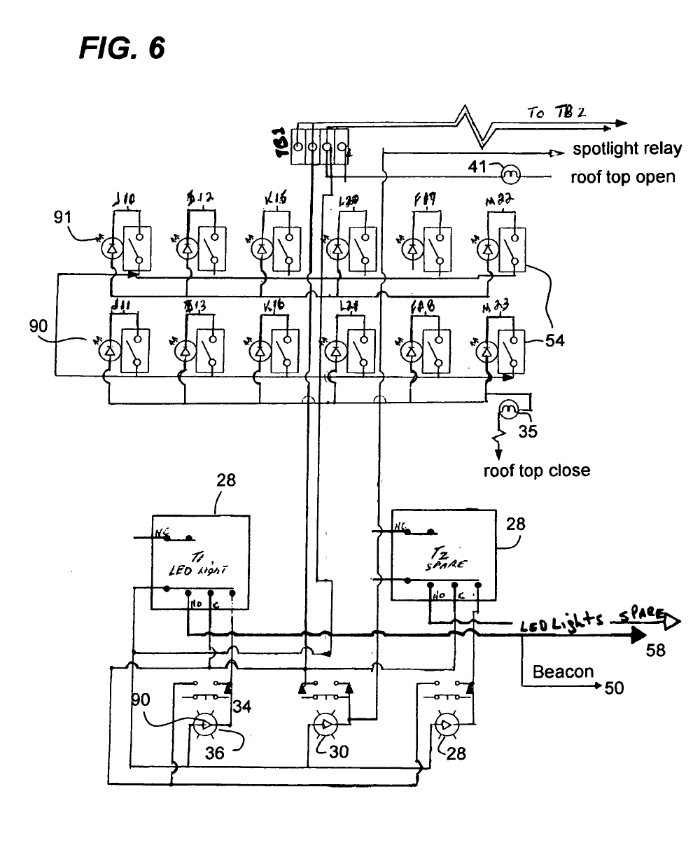

FIG. 7 Schematic view of a wifi relay board.

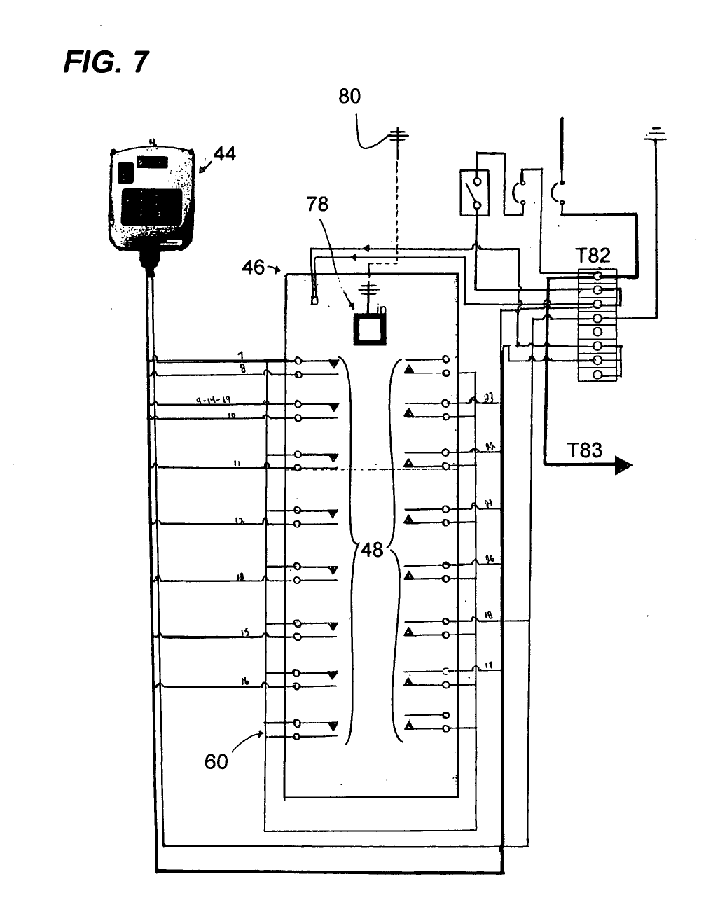

FIG. 8 Schematic view of digital actuators, main LED, spotlight relay board.

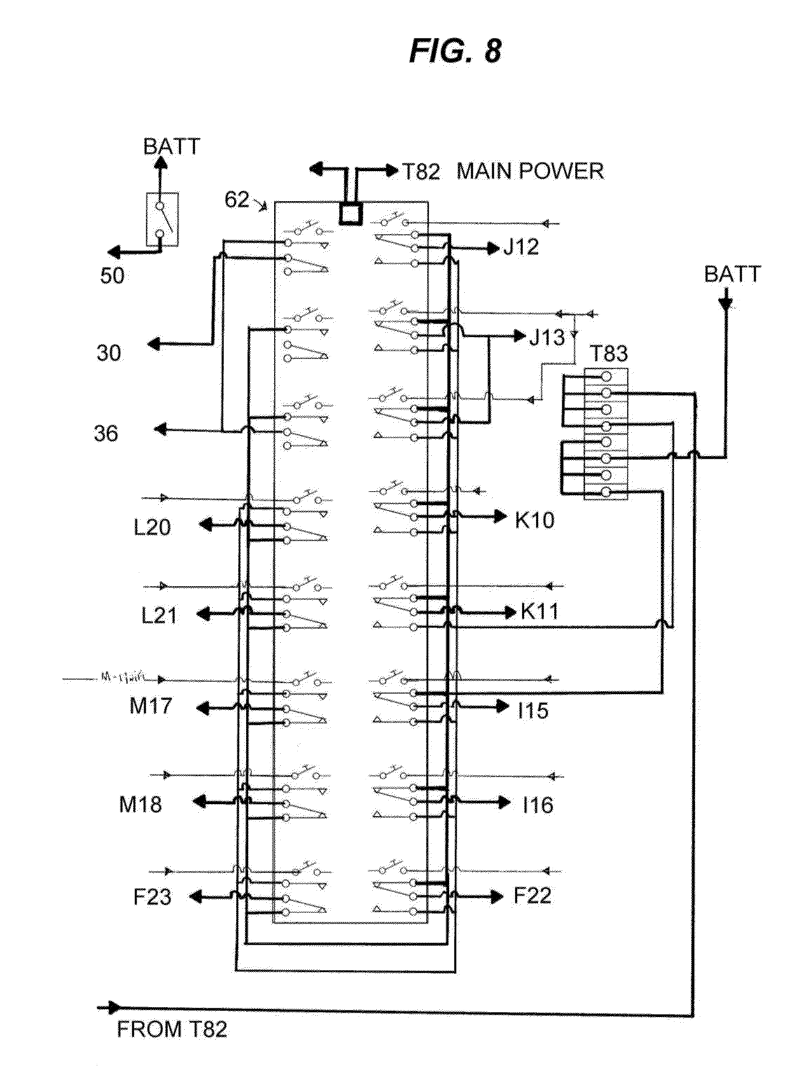

FIG. 9 Front view of a pendant.

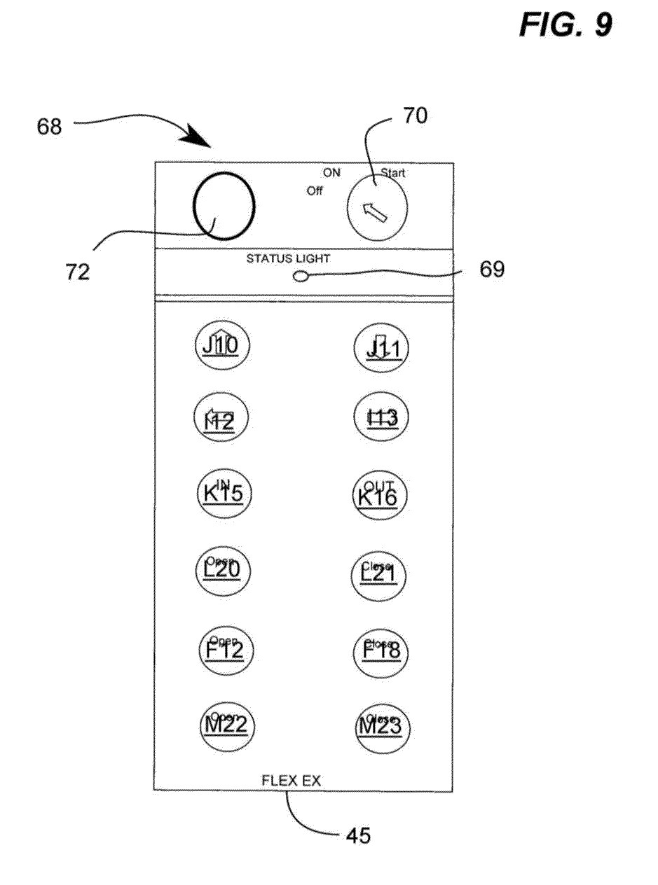

### DETAILED DESCRIPTION OF THE PREFERRED EMBODIMENT

A Solar powered system for operating the gates and chutes of a fracking silo (10) has 4 types of operations:

Manual switching operation; Remote system with a twelve button pendant; WIFI with a button controller program that can be downloaded to a pad, phone, laptop and/or a desktop in a vehicle; Extranet with modem.

Glass pack leak and vapor proof solar batteries (12) delivering 12 VDC of power and a capability of 1000 amp/hr.

12 VDC actuators (14) to activate:

a) ROOF TOP LID (16)—To Open (M22) and Close (M23).

b) GATE #2 SMALL BIN (18)—To Open (F12) and Close (F18).

c) GATE #1 LARGE BIN (20)—To Open (L20) and Close (L21).

d) CHUTE (22) Retreat (K15) and Extend (K16); Rotate left (I12) and Rotate Right (I13); Go up (J10) or go down (J11).

g) DUSTER FAN ON ROOF (29)—On a 5 minute timer when manually switched on.

h) S2—LED Spot Light (30) to illuminate the two gate level indicators at night for 64 minutes, then shuts off. Reset by pressing the spot light switch (32), will be lit red when energized. If timer expired before manually shutting switch (32), press in to reset to off.

i) S1—Main Panel LED (36) light also on the 64 minute timer when manually switched on. When using the remote system pendant S1 (36) and S2 (30) come on automatically, they can be switched off if the operator chooses to do so.

Operation: Power on Drawing #2

A) Turning on a main power toggle switch (38) puts the system on line, ready to be operated;

B) A 12 VDC is supplied by input switch (38) to a Flex 12EX System (44) and to a Digital Relay board (46) that provides a 12 VDC input power with 16 electronic relays (48);

C) 12 VDC is sent to the manual switches (34) then routed to the digital relay board (46) to activate the chute (22), gates (18, 20) & roof top lid (16).

D) All manual switches (34) have 12 volts dc to operate their LED internal lights. Timers are activated by the manual S1 (36), S2 (30) or by remote. S3 (28) is the only switch that can only be operated manually;

E) A warning beacon (50) on top of a control panel (52) is also energized, warning people that the system is live and parts could be in motion at any time;

F) System is now ready for operation.

Operation: Manual Switching Drawing #1

A) Roof top lid (16) is always in the closed position indicated by a red LED light at the bottom of a momentary switch (54).

B) When pressing the momentary switch (54) upward (M22) the rooftop lid (16) will start opening and the red LED light will go off. When the roof top lid (16) is fully open a green LED light (41) located at the top of the momentary switch (54) turns on when activated by a micro switch (56).

C) When closing (M23) the rooftop lid (16) the green LED (41) light will go off and the red LED light (35) will come on indicating through another micro switch (56′) that the rooftop lid (16) is fully closed.

D) Gate #2 (18) is opened (F17) by pressing the momentary switch (54) and while doing so, the operator can easily look at the gate indicator to see if he wants to open it 10%, 50%, or 100%. To close the gate (18) press the momentary switch (54) (F18) and the gate #2 (18) will start closing until it reaches 0% (fully closed).

E) Gate #1 (20) is opened (L20) by repeating the same operation as for gate #2 but using the appropriate switch, of course e.g. closed (L21).

F) To retreat (K15) the chute (22), press yet another momentary switch (54″) and the chute (22) will go in. To extend (K16) the chute (22), press the momentary switch (54″) and the chute (22) will go out. The chute (22) can be stopped anywhere from full extension or retraction.

G) To rotate the chute (22) left (I12) press still another momentary switch (54′″) and the chute (22) will start moving to the left it can be stopped to any desired spot from its full left motion. To rotate the chute to the right (I13) press the momentary switch (54′″) and the chute (22) will start moving to the right (I13) it can be stopped to any desired spot from its full right motion.

H) To move the chute (22) up (J10), press a fifth momentary switch (54″″) and the chute (22) will travel up until it reaches its maximum elevation or it can be stopped at any desired height. To move the chute down (J11) press the momentary switch (54″″) and the chute (22) will travel to its maximum lower position or it can be stopped to any desired height.

I) S1—Main panel LED switch (36) is controlled through a timer set for 64 minutes and it turns on an interior control panel string of LED lights (58) illuminating it like daylight. If forgotten to be turned off by the operator it will turn itself off after the 64 minutes. A red main panel LED light (60) in the main panel LED switch (36) turns on to indicate that the timer has finished its cycle. Toggle the main panel LED switch (36) off to reset, then on to turn the main light on again.

J) S2—LED Spot Light switch (30) is an On/Off switch that is also controlled through the same timer as the Main panel LED switch (36), but it turns on a LED spot light (37) that provides back light to the Gates (18, 20) at night, making it easy to read the gates level indicators. If the switch is needed to be turned off during daytime, the red LED of the switch will be lit, indicating to the operator that spot light is de-energized. This action will also bypass the timer.

All switches (54 to 54″″) control a relay on an electronic digital relay board (60), sending an DC signal to an actuator relay board (62) switching its DC signal to operate a 12 VDC 30 amp relay (61) to activate the actuator relay board (62) which draws between 5 to 25 amps while in operation.

The DC power from the solar batteries (12) goes to a terminal block (64) and a 30 amp relay (66) and a low voltage switching is used for switching polarity to move the actuator in or out.

Operation: Remote

A) On a pendant (68), a pendant on/off switch (70) is needed to be turned to the right for 2 seconds to turn the entire system on, including the control panel LED lights (58) and the LED spot light; (37), provided that the main power toggle switch (38) was turned on.

B) The pendant (68) has 12 buttons. A pendant status light (69) on the top of the pendant (68) indicates that it is communicating with a Flex 12 EX system receiver/transmitter (45). If the pendant (68) is left unused for more than 5 minutes it will shut down the entire system. When this happens, the pendant on/off switch (70) will have to be turned to the left to OFF, and then to the right for 2 seconds to energize the system again;

C) A panic shut off button (72) is located to the left of the on/off switch (70) which will turn everything off instantly if pressed down.

D) At this stage the status light (69) can be seen on the Flex 12EX Transmitter/Receiver (45).

Operation: WIFI

A) A WIFI Board (78) is inserted into the digital relay board (46) and a power supply (76) is hooked-up to it. An antenna (80) is hooked up to the WIFI Board (78).

B) A WIFI controller program is downloaded into a pad, smart phone or laptop and then all the necessary data, addresses etc are fed into the equipment to be used to control the selected buttons to turn on the chutes (22), gates (18, 20) and rooftop lid (16).

C) A locking mechanism prevents other pads, phones, laptops to be used since each silo (10) has their distinctive addresses.

D) Various buttons programs can be selected by the customer to best fit their operation.

Operation: Extranet

A) Using the WIFI board (78) and a modem to communicate data through internet to a laptop, desktop to initiate control of the chutes (22), gates (18, 20) and rooftop lid (16);

C) Use of cameras (not shown) located at various places to visually see the actions of the chutes (22), gates (18, 20) and rooftop lid (16). can be installed upon the request of the customer;

D) Sensors (not shown) to indicate the actions of the chutes (22), gates (18, 20) and rooftop lid (16), coupled with a simple program indicating the movement of each actuator that let the operator know where each chutes (22), gates (18, 20) and rooftop lid (16);

E) Limit switches (not shown) are also used to indicate full open, full close or full left, full right, full in or full out;

F) Extra LED spot lights (37) around the top of the silo (10) shining down for night use with strategically placed cameras are part of this package;

G) Optionally, a cell phone chip (not show) can be installed to operate via a cell phone (not shown) the action of the chute (22), gates (18, 20), and rooftop lid (16).

Operation: Air Traffic Warning

A) A 12 VDC LED red photo cell actuated beacon (13) is located on top the silo (10) as a precaution to warn aircraft of a tall object is in their view. The beacon can also be turned off when the silo is being moved by road.

Operation: Battery Junction Box

A) This battery box is totally weather proof housing three 600 amps bus bar (84);

B) Four positive leads (welding cable hot) from the four batteries goes to the positive bus bar (84);

C) Four negative leads (welding cable hot) from the four batteries goes to the negative bus bar (84);

D) From these two bus bars (84) two 10AWG wires provide input power to the control panel (52) through a 30 amps breaker and an on/off switch that energized the entire system. Then a 25 amps solar charging system using 10AWG wires provides battery charging which is controlled by a solar charger controller (86) from two 140 watts solar panels (88);

F) A DC lighting arrestor (90) is also hooked-up to the bus bars (84) in case of electrical lighting strikes which will take the jolt preventing damages to any other electrical/electronic parts within the system;

G) A ground is provided from the control panel to the DC battery Junction box and then routed from the DC junction box to the two battery boxes.

Operation: Battery Boxes

A) The two battery boxes are independent of each other. Housing two batteries (12) each;

B) The Negative cables (hot) are hooked-up to each individual negative post of each battery (12);

C) The positive cables are individually routed through a 400 amp fuse in case of dead short therefore taking out the battery(ies) (12) within milliseconds;

D) All cables are the same length and are routed through LT tubing for protection and LT weather proof connectors are used on the Junction Box (82) and on the two battery boxes;

Operation: Solar Controller

A) The solar charger controller (86) has the ability to open the circuit of the solar panels (88) if the batteries (12) are fully charged;

B) The solar charger controller (86) is also equipped with a battery temperature sensor that controls the charge rates of the batteries (12) depending on the outside temperature;

C) The solar charger controller (86) also displays battery charging amperages and voltages.

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1.) A solar powered system for operating the gates, chutes, and lid of a fracking silo, said solar powered system comprising at least one solar panel adapted to be attached to an outer surface of said fracking silo; at least one solar power battery adapted to be housed within a base portion of said fracking silo, each said at least one solar power battery being electrically connected to said at least one solar panel and adapted to store the solar power absorbed by said at least one solar panel; and a control panel adapted to be placed within said fracking silo and electrically connected to said at least one solar power battery, and adapted to control and transfer the solar power stored by said at least one solar power battery, wherein said control panel includes a solar charger control device adapted to regulate said at least one solar power battery and transfer a desired amount of solar power therefrom to actuators within said fracking silo to thereby open and close said gates and lid, and move said chutes of said fracking silo.

2.) The solar powered system of claim 1, wherein said control panel further includes switches, electronic relays, and a 64 minute timer, adapted such that a predetermined sequence of operations can be performed by said solar power system to power said gates, chutes, and lid of said fracking silo at predetermined times and following predetermined events.

3.) The solar powered system of claim 2, wherein said switches are manually operable.

4.) The solar powered system of claim 1, wherein said control panel further includes a remote control mechanism, such that said control panel is adapted to be controlled from a remote location.

5.) The solar powered system of claim 4, wherein said remote control mechanism further includes a wireless internet communication mechanism adapted to be accessed and used by a controller remotely via an internet connection.

6.) The solar powered system of claim 5, wherein said wireless internet communication mechanism includes a WIFI controller program, a WIFI board, a WIFI modem, a WIFI antenna, and a WIFI locking mechanism adapted to lock unauthorized users from accessing said wireless internet communication mechanism.

7.) The solar powered system of claim 1, wherein said solar charger control device includes a solar power battery temperature sensor adapted to send temperature information of said at least one solar power battery to said solar charger control device.

8.) The solar powered system of claim 1, further comprising a direct-current to alternating-current (DC/AC) converter mechanism electronically connected between the at least one solar power battery and said gates, lid, and chute of said fracking silo.

9.) A solar powered fracking silo, said fracking silo including a small bin gate opened and closed by an actuator, a large bin gate opened and closed by an actuator, at least one chute that is extendable and rotatable by actuators, and a roof top lid opened and closed by an actuator; and a system for operating said gates, chutes, and lid of said fracking silo comprising at least one solar panel attached to an outer surface of said fracking silo; at least one solar power battery housed within a base portion of said fracking silo, each said at least one solar power battery being electrically connected to said at least one solar panel and adapted to store the solar power absorbed by said at least one solar panel; and a control panel adapted to be placed within said fracking silo and electrically connected to said at least one solar power battery, and adapted to control and transfer the solar power stored by said at least one solar power battery, wherein said control panel includes a solar charger control device adapted to regulate said at least one solar power battery and transfer a desired amount of solar power therefrom to said actuators within said fracking silo to thereby open and close said gates and lid, and move said at least one chute of said fracking silo.

10.) The solar powered system of claim 9, wherein said control panel further includes switches, electronic relays, and a 64 minute timer, adapted such that a predetermined sequence of operations can be performed by said solar power system to power said gates, chutes, and lid of said fracking silo at predetermined times and following predetermined events.

11.) The solar powered system of claim 10, wherein said switches are manually operable.

12.) The solar powered system of claim 9, wherein said control panel further includes a remote control mechanism, such that said control panel is adapted to be controlled from a remote location.

13.) The solar powered system of claim 12, wherein said remote control mechanism further includes a wireless internet communication mechanism adapted to be accessed and used by a controller remotely via an internet connection.

14.) The solar powered system of claim 13, wherein said wireless internet communication mechanism includes a WIFI controller program, a WIFI board, a WIFI modem, a WIFI antenna, and a WIFI locking mechanism adapted to lock unauthorized users from accessing said wireless internet communication mechanism.

15.) The solar powered system of claim 9, wherein said fracking silo further includes a duster fan located adjacent to said roof top lid.

16.) The solar powered system of claim 9, wherein said solar charger control device includes a solar power battery temperature sensor adapted to send temperature information of said at least one solar power battery to said solar charger control device.

17.) The solar powered system of claim 9, further comprising a direct-current to alternating-current (DC/AC) converter mechanism electronically connected between the at least one solar power battery and said gates, lid, and chute of said fracking silo.
